(19) United States
(12) Patent Application Publication
(10) Pub. No.: US 2011/0106791 A1
(43) Pub. Date: May 5, 2011

(54) METHOD FOR ENRICHING DATA SOURCES

(76) Inventor: Enrico Maim, Paris (FR)

(21) Appl. No.: 12/919,375

(22) PCT Filed: Feb. 25, 2009
(86) PCT No.: PCT/FR09/00204

§ 371 Date: Aug. 25, 2010

(51) Int. Cl. G06F 17/30

(52) U.S. Cl. 707/722; 707/756; 707/705; 707/736; 707/E17.044

(57) ABSTRACT

In a first aspect, the invention relates to a method implemented in a computer environment for identifying enrichment information relative to starting information, characterised in that the method comprises the following steps: (a) accessing via a network a first information source in order to collect first information in response to a first request; (b) converting said first information into a first set of data structured according to a plurality of first attributes; (c) applying context information to a mapping source in order to identify at least one second source of information capable of providing information that can be used for enriching the first information; (d) accessing via the network the second source of information in order to collect therefrom second information in response to a second request containing one or more criteria contained in the first request and/or one or more attribute values of the first set of structured data; (e) converting said second information into a second set of data structured according to a plurality of second attributes, at least some of which are linked to first attributes by inter-attribute mapping information provided by the mapping source; and (f) presenting the data including data of the first data set and data of the second data set combined according to said mapping information.

### STATE OF THE ART

The method of the present invention allows a user to combine, with a single “enrichment” instruction, a (multidimensional) data source with another, in order to enrich it with comparable information, i.e. with complementary or alternative information.

Nowadays, the only means for automatically enriching multidimensional data sources are those of the art of database manipulation, using specific programming instructions to combine data and arrange the result to fit in the desired presentation. In particular, when the data sources are web services, the users don't have any readily available tool to automatically enrich a first data source with comparable information provided by a second data source.

One will mention the meta search engines, for example for online shopping, to compare product prices or other alternative information (i.e. competing information) such as product delivery conditions, but these are necessarily carried out in a specific and dedicated environment.

The present invention aims at proposing a data source enrichment method that is transparent in the sense that it doesn't require any change in the way the user accesses data sources, especially on the Web. Moreover the present invention enables enrichment by combining data sources whose attribute values are not necessarily fully instantiated but represented as domains of values and/or sets of constraints (moreover, the constraints being able to contain variables representing references to attributes of the same row or other rows, as in a spreadsheet).

### SUMMARY OF THE INVENTION

In a first aspect, the invention relates to a method implemented in a computer environment for identifying enrichment information, characterized in that the method comprises the following steps:

(a) accessing via a network a first information source in order to collect first information in response to a first request;

(b) converting said first information into a first set of data structured according to a plurality of first attributes;

(c) applying context information to a mapping source in order to identify at least one second source of information capable of providing information that can be used for enriching the first information;

(d) accessing via the network the second source of information in order to collect therefrom second information in response to a second request containing one or more criteria contained in the first request and/or one or more attribute values of the first set of structured data;

(e) converting said second information into a second set of data structured according to a plurality of second attributes at least some of which are linked to first attributes by inter-attribute mapping information provided by the mapping source, and

(f) presenting the data including data of the first data set and data of the second data set combined in function of the said mapping information.

According to a second aspect, the invention proposes a method implemented in a data-processing environment to identify enrichment information, characterized in that it comprises the following steps:

(a) access through the network a first information source in order to obtain a first data set structured according to a plurality of first attributes in response to a first request;

(b) apply context information to a source of mapping in order to identify at least one second data source able to deliver data to enrich the first data set;

(c) access through the network the second data source in order to obtain a second data set structured according to a plurality of second attributes in response to a second request containing one or more criteria contained in the first request and/or one or more attribute values of the first data set, the second attributes being related to first attributes as per the attribute mapping information provided by the source of mapping; and

(d) present data comprising the data of the first data set and the data of the second data set, combined according to key attributes predetermined among the second attributes.

The invention proposes according to a third aspect a method implemented in a data-processing environment to identify enrichment information, characterized in that it comprises the following steps:

(a) access through the network a first information source in order to obtain a first data set structured according to a plurality of first attributes in response to a first request;

(b) apply context information to a source of mapping in order to identify at least one second data source able to deliver data to enrich the first data set;

(c) access through the network the second data source in order to obtain a second data set structured according to a plurality of second attributes in response to a second request containing one or more criteria contained in the first request and/or one or more attribute values of the first data set, the second attributes being related to first attributes as per the attribute mapping information provided by the source of mapping; and

(d) present data comprising the data of the first data set and the data of the second data set, combined in response to the existence of alternative values, in the second data set, of second attributes mapped on first attributes.

In the method above, it is advantageous that the said alternative values are selectively displayed according to the position of a pointing device on a value of the first data set, alternative values for the attribute corresponding to the value on which the pointing device being displayed points.

According to a fourth aspect, the invention proposes a method implemented in a data-processing environment to automatically enrich data organized in a multiplicity of (multidimensional) attributes provided by a data source such as a web site, characterized in that it comprises the following steps:

(a) access a first data source to obtain first data;

(b) automatically obtain data alternative to the first data, from at least one second data source;

(c) automatically obtain data complementary to the first data, from a third data source; and

(d) combine the said alternative data and the said complementary data, so as to be able to selectively present the said first data, the alternative data and the complementary data.

Certain preferred but nonrestrictive aspects of this method are the following:
the said third data source providing the data complementary to the first data source is the second data source itself.
the step (c) further consists in obtaining from the first or the third source, data complementary to the said alternative data obtained from the second source.
the step (b) further consists in obtaining automatically from the first source, data alternative to the alternative data obtained from the second source, these additional alternative data being also enriched at the step (c).
then the step (c) comprises a sub-step for detecting the existence of alternative attributes in the first or second source.
the method comprises moreover a step of conversion of the data resulting from the data sources into data set (set of rows) structured according to a plurality of attributes.
the method comprises moreover a step of graphic treatment of the presentation of the first data provided by the first source to include in it the alternative data and the complementary data.
the alternative data and the complementary data are presented selectively according to the attribute values selected by the user by using a pointing device at the level of the original presentation of the first data.
the method comprises a mapping of attributes for each pair of sources of which the data are to be combined.
the step (b) comprises a filtering on one or more attributes.
the step (c) comprises taking into account of meta-data of dependencies between attributes.
the method comprises moreover a step consisting in automatically obtaining data complementary to the alternative data.
the method comprises moreover a step consisting in automatically obtaining data alternative to the complementary data.
the method comprises moreover a step consisting in automatically obtaining data complementary to the complementary data.
the method comprises moreover a step consisting in automatically obtaining data alternative to the alternative data.
the data sources are selected among the traditional multidimensional data sources and the data sources whose attribute values can be represented by domains of values or constraints on values.
the said constraints depend on variables representing references to values of attributes for the same data row or for another data row.
when an attribute of a data row (R) which enriches a first source comprises a reference to an attribute of another data row (R′), or reciprocally when an attribute of another data row (R′) comprises a reference to an attribute of a data row (R) which enriches a data row of the first source, the said other data row (R′) is added in the combined data (S1r), even when no data row of the first source corresponds to it.
the said other data row is included in the step (d) only in the presence of consistent constraints.
there exist attributes of the type “real-time” and temporal constraints on them, and in which the step (d) is implemented by taking into account constraints on attributes of the type “Real-time” to allow a management of enrichments by alternative data and complementary data taking the time into account.
the method involves using a constraint solver.
the data sources from which the data of the first data source are to be enriched comprise resources belonging to a user context which is configurable.
the user context comprises web pages in other tabs of a web browser, the said browser being the means to access the data sources.
the user context comprises web pages pertaining to a recent browsing history in a web browser.
the user context comprises web pages pertaining to the context of user of another user having a proximity relationship with the user in question.
the user context is obtained according to the geolocation information of the user.
the user context is obtained from the content of data sources previously accessed by the user.
the step (d) comprises selective collapsing/expanding of data rows from the first data source and the enrichment data sources.
when the said first data gather a plurality of data rows of the said the first source and aggregate their values, then the step (d) accordingly aggregate the enrichment data rows of the first data.
According to a fifth aspect, the invention proposes a method to carry out a mapping between attributes of two multidimensional data sources, in order to implement the method according to one of claims 1 to 33, each data source being able to return results in response to a request, characterized in that it comprises the following steps:

(a) display results of similar queries applied to the two data sources in two respective display zones,

(b) by actions using a pointer device, establish correspondences between displayed data from the first source and displayed data from the second source, and

(c) map the attributes of the data of the first source and the second source for which correspondences were established.

### SHORT DESCRIPTION OF THE DRAWINGS

FIG. 1 presents (in a “pop-up widget” provided with tabs, in its first tab) alternative information provided by a first secondary source.

FIG. 2 presents (in a second tab of the same “pop-up widget”) alternative information provided by a second secondary source.

FIG. 3, illustrates the fact that the user slips the mouse cursor on the representation of an attribute which corresponds to a functional or multivalued dependency key of another source which is available in the context, from which data are then presented to her with their complementary attributes.

FIGS. 4 and 5 illustrate schematically various cases of mapping creation between sources which are already in the form of tables.

FIG. 6 schematically illustrates a traditional Webpage (on the left) having products (books sorted by authors) and the result of extraction (on the right) in the form of table (having the columns: Photograph, Author, ISBN, Title, Language); the bidirectional arrow indicates the extraction (from left to right) and the synthesis (from right to left) as the method of the invention allows it.

FIG. 7 presents a webpage presenting the flights of plane for which the user selects an attribute “One-way flight” to extract.

FIG. 8 shows the fact that the extractor then creates the first column “One-way flight” of the extracted table, corresponding to this attribute.

FIG. 9 presents the complete table thus built.

FIG. 10 shows a table built according to the same method for another airline page.

FIG. 11 illustrates creation by the user of a mapping between two pages of airline websites for which extractors already exist: having these two pages respectively opened in two different tabs of the browser, the user selects the option “Map with” to create a mapping between the current page and the other page which will then be presented one below the other.

FIG. 12 shows the fact of taking the graphic object “Paris—Charles de Gaulle (CDG)” located in second half of the page, and of slipping it to the top of the figure.

FIG. 13 shows the fact of dropping the object slipped, onto the graphic object “Paris” located on first half of the page.

### BEGINNING OF DESCRIPTION

Automatic method of enrichment of a multidimensional data source such as a Web site, enabling in particular
at the time of accessing a web site, to automatically obtain alternative data from other sites (for example to obtain from various airlines a list of flights for the same destination) in order to be able to compare them,
and to automatically combine information of different types from several websites (for example, by visiting the site of an airline company, hotels are automatically suggested to the user, for the selected destination and dates).

The alternative data comprise alternative attributes, i.e. which are source-dependent. For example, for two e-commerce sites selling products (these products being common products manufactured by other entities) the attributes such as typically the “price” and the “delivery time” could be alternative, whereas the attributes characterizing the products themselves are source-independent (since these attributes depend on the manufacturers and not on the vendors). The alternative attributes can be detected automatically as being those which potentially have a value contradicting the other source.

Thus the data sources are enriched by complementary data (source-independent) and by alternative data (source-dependent).

In the case of accessing a source such as a website, its data not being provided in a structured and immediately exploitable way, the method of the invention includes a step of conversion of the data sources into set of rows structured according to a plurality of attributes (i.e. converting into a “table”)¹, and the rows resulting from enrichments are then converted back, so that for the visible part² of the first source accessed, the enrichments are presented to the user directly within the original presentation of the first source. These enrichments are presented to the user selectively, in function of the said attributes selected by the user directly at the level of the original presentation. ¹In the continuation, by “source” one understands “source data structured according to a plurality of attributes”; each data of a source is a “row” (or “data set”); the terms “attribute” and “column” are used in an interchangeable way. A value of attribute of a row can be characterized by constraints representing a possible set of values (this is called “domain”). By “attribute” one understands, according to the context, “attribute” or “value of attribute” or “possible values of attribute” (the term “value of attribute” is explicitly used only in the ambiguous cases, to distinguish the attribute itself from the value that it takes). By “FD” and “MVD”, one understands “Functional Dependence” and “Multivaluée Dependence” respectively. By “user” one understands the user (human) or a programmatic access instead of the user.²The visible part is the data presented to the user, generally the data source being larger than the data presented to the user.

In the state of the art, to carry out such combinations of sources, queries—in particular including unions and joins (of the relational calculus) or similar specific operations require to be defined and implemented explicitly. Whereas the method of the invention is generic and transparent and can be triggered (spontaneously according to the context) on the basis of the algorithm presented hereafter and on the basis of predetermined³ information comprising (i) the direct or indirect mapping of attributes for each pair of sources to be combined, and (ii), associated to each source taken independently, one or more attributes serving as “filter” (or a plurality of filter candidates) and/or meta-data of dependencies⁴ between attributes. ³Predetermined by automatic processes or not, in particular: mapping can be based on semantic meta-data; the filter or the candidates filters will be those which the data source in question allows; the dependencies can sometimes be automatically given by making the closed world assumption.⁴The concepts of functional dependency (FD) and multivalued dependency (MVD) (one or more key attributes determining one or more other attributes) are well-known in the field of the normalisation of relational databases (see in particular the articles of Ronald Fagin).

The method of the invention thus makes it possible to enrich the alternative data obtained from a source by additional information obtained of another source (which can even be the first one), and reciprocally to enrich the complementary data obtained from a source by alternative data obtained of another one (which can even be the first one), and also to enrich the alternative data by other alternative data (even from the first source) and the complementary data by other complementary data (even from the first source).

The method of the invention functions as well on traditional sources and sources comprising the attributes represented by domains or constraints, i.e. disjunctions (or intervals) of possible values given explicitly and/or domains represented implicitly by constraints such as equations and inequations, the constraints being able to contain variables representing references to attributes of the same row or other rows (as in a spreadsheet⁵). ⁵As in a worksheet of a spreadsheet, but with the difference that here an attribute can be specified by a plurality of constraints such as “<A10+2*B27, >C15” (i.e. not only equalities but even inequalities, etc.), here A10 B27 and C15 representing attributes (cells) of other rows of the same source.

When an attribute of a row of a source which enriches the first source comprises a reference to an attribute of another row, or reciprocally when an attribute of another row has a reference to an attribute of a row which enriches the first source, the said another row is tentatively added in the result of enrichment, even when no row of the first source correspond to it. For each attribute of type “Real-time” of the said other row, a constraint “>NOW” (later than now) is added in there to make it possible to take account of constraints of sequence between rows, and to avoid generating other rows violating such constraints. In addition, a start date of validity (BS, “Belief Start”) and a validity termination date (BE, “Belief End”) are optionally associated (as meta-attributes) along with the rows, in order to make it possible to memorize and to temporally⁶ manage the carried out enrichments and to invalidate (by instantiating the end of validity) the memorized rows which do not correspond any more to current enrichment. ⁶The temporal management of data makes it possible to compare several enrichments carried out in time (for example to compare predictions of future expenditure carried out at various moments) and automatically determine differences between their aggregations.

The implementation of this method is later described in the present text, in the classical (state-of-the-are⁷) approach of constraint solving. The described implementation can readily be used with generic solvers for the manipulated attribute types: reals, integers, booleans, character strings, lists, etc. ⁷Such as those used in Constraint Logic Programming.

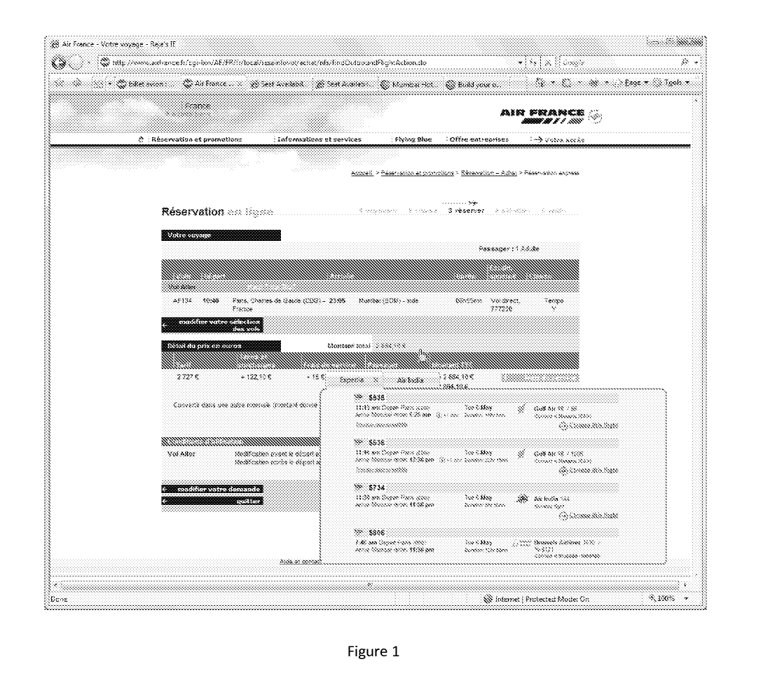

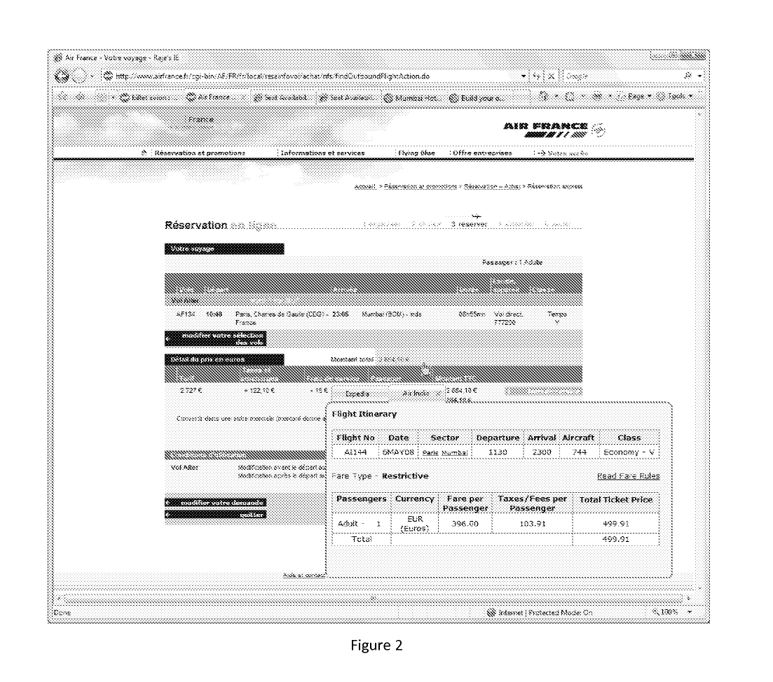

The sources enriching the first source are those being in the context of the user. The definition of the context is configurable by the user. The context can for example comprise the webpages which are in the other tabs of the current instance of the web browser (as illustrated in FIGS. 1 and 2 further described), or can be composed of the most recently accessed pages, or of the union of the contexts of “close” users, as described at the end of this text. The selection of the sources enriching a current source takes also account of information of local context such as the geolocation or of the contents of the sources composing the context of the user or of the close users.

Illustrations

Let's now illustrate the concept of enrichment of source S1 with a plurality of S2 sources of the context (represented here by the tabs of the same browser instance).

As presented in FIGS. 1 and 2, when the user slips the cursor of the mouse onto the representation of an attribute corresponding (by mapping) to an alternative attribute of another source available in the context, the system presents to her this alternative attribute. In fact the alternative attribute in question in these figures is the price of the flight, thus other flights (and possibly also same flight) are presented with their alternative prices.

FIG. 1 presents (in a “pop-up widget” provided with tabs, in its first tab) other flights provided by a first source S2 and FIG. 2 presents (in a second tab of the same the “pop-up widget”) a flight provided by a second S2 source.

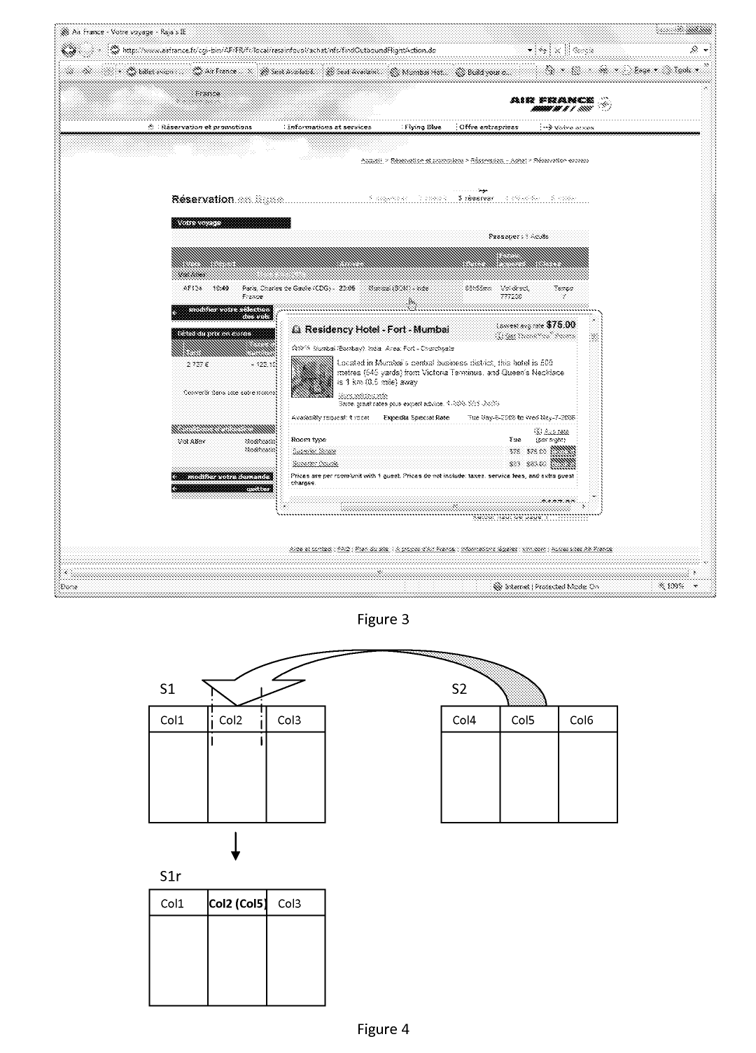

On the other hand, like illustrated in FIG. 3, when the user slips the cursor of the mouse on the representation of an attribute which corresponds (by mapping) to a key (key of functional or multivalued dependency) of another source available in the context, the system presents to her the data of the latter with their complementary attributes. In fact the key attribute in question in this figure is the destination of the flight and the additional details presented are the hotels available at this destination. Of course, in certain cases (not shown in these figures) alternative and complementary attributes are presented together (for example in different tabs from same a pop-up widget). It should be noted that enrichments are not done directly using the visible parts of the respective S2 sources, but by accessing these sources (again) to provide the rows compatible to the rows of the visible part of S1.

Mapping

Primarily a mapping between S1 and S2 is used to indicate to the system that such and such attributes of S1 mean the same thing as such and such attributes of S2, possibly after transformations. Various methods exist to give the semantics of the attributes, in particular in the contents of the sources themselves (like the micro-formats for example). Hereafter only the implementation of explicit mapping of attributes is described.

The user can provide to the system the mapping of objects presented to the screen, in particular by simple dragging and dropping.

FIGS. 4 to 13 illustrate schematically various cases of creations of a mapping, initially between sources which are already in the form of tables, then between sources which are websites but such that the respective extractors can translate them into tables and thus see in there the multidimensional data that they provide.

FIG. 4 shows that the column Col5 of S2 being dragged and dropped on the column Col2 of S1, the user indicates to the system that these columns contain values that can be combined, thus the values from Col5 will be displayed in the resulting table (S1r) in the column “Col2(Col5)”.

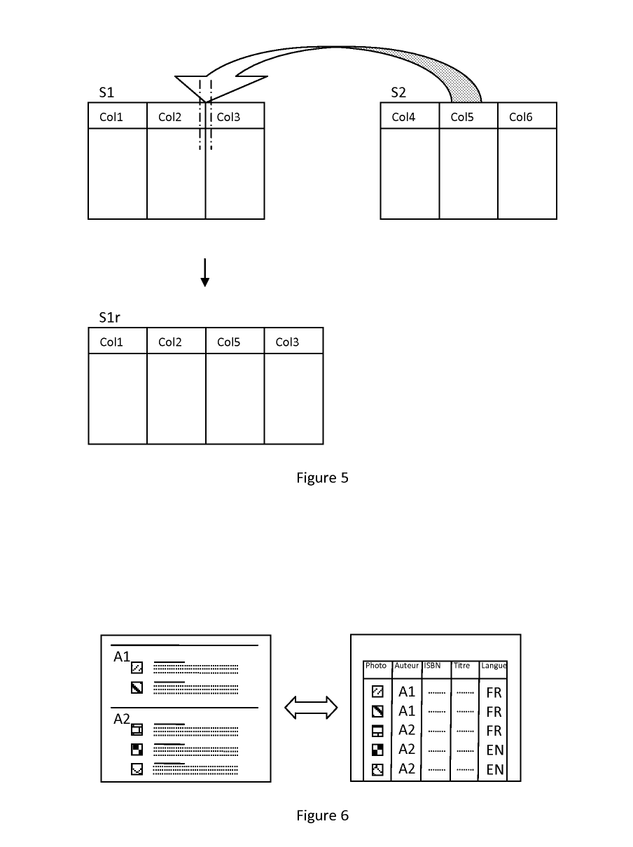

FIG. 5 shows the case of addition of an attribute of S2 missing in S1. The column Col5 of S2 dropped between the columns Col2 and Col3 of S1, the values from Col5 de S2 will be displayed in the resulting table (S1r) within a new Col5 column placed between Col2 and Col3.

These FIGS. 4 and 5) illustrate the areas schematically (delimited in dotted lines in the figures) making it possible to distinguish these two cases of drag and drop.

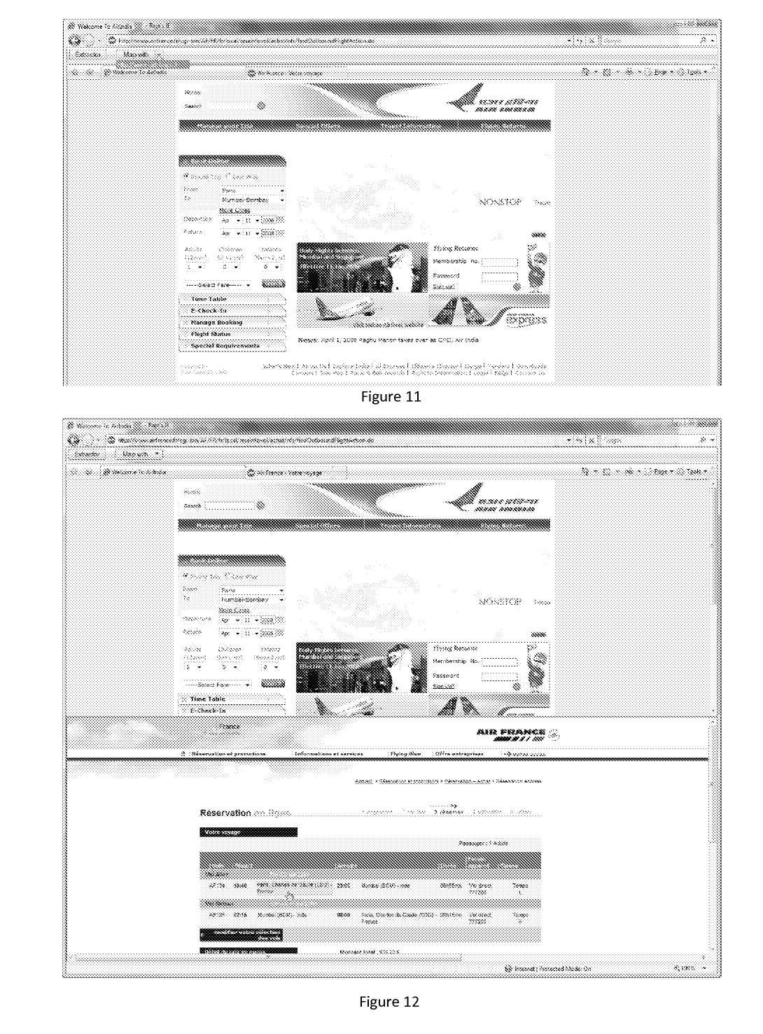

A mapping can also be created directly from the original presentation of the sources in question. FIGS. 11 to 13 show the mapping method on web pages to which extractors have been associated.

Extraction/Synthesis

The method of extraction/synthesis of data makes it possible to carry out enrichments directly at the level of the webpages. Indeed, the data can be provided in the same presentation as that of the webpage which is used as source. FIG. 6 schematically illustrates a traditional webpage (on the left) having books sorted by authors (A1, A2, etc) and the result of extraction (on the right) in the form of a table (with the columns: Photograph, Author, ISBN, Title, Language); the bidirectional arrow indicates the extraction (from left to right) and the synthesis (from right to left). It should be noted that providing, by means of the synthetizer, the enrichment data in their original presentation could be inserted in pop-up widgets superimposed into another page, as illustrated in FIGS. 1 to 3 (as illustrated later).

An extractor provides a table from the data in a Web page. It must thus indicate on the one hand the request (URL, parameters GET or POST) and on the other hand how to extract the data of the page. It can also manage the pagination and download several pages of results automatically.

The method of creation of an extractor, from a webpage containing a set of multidimensional data, is semi-automatic. First of all, the user selects in the webpage one or more objects each corresponding to a row of the table, and indicates which object of the page corresponds to which row of the table to generate. The system compares the paths of these objects and built a generic path covering at least the objects indicated by the user.⁸ The system can thus determine the values for each object, and present the table thus obtained to the user. 8In a preferred implementation, all the objects corresponding to the path thus built are highlighted and the user can refine the way by indicating additional objects or by unselecting highlighted objects. The system then refines the way to respect these constraints. When the user is satisfied with the selection of objects, she specifies for one of these objects (the “object models”) all the attributes which will correspond to the columns of the table. For each attribute, an object in the page, a name of column (which can be taken by default of the page itself) and, if necessary, the HTML attribute to be extracted (for example, for the links, she has the choice between the value of the attribute href or the text of the link). The system establishes, for each attribute, a pair (name of column; path), the path relating to the model object, and records this information in the extractor.

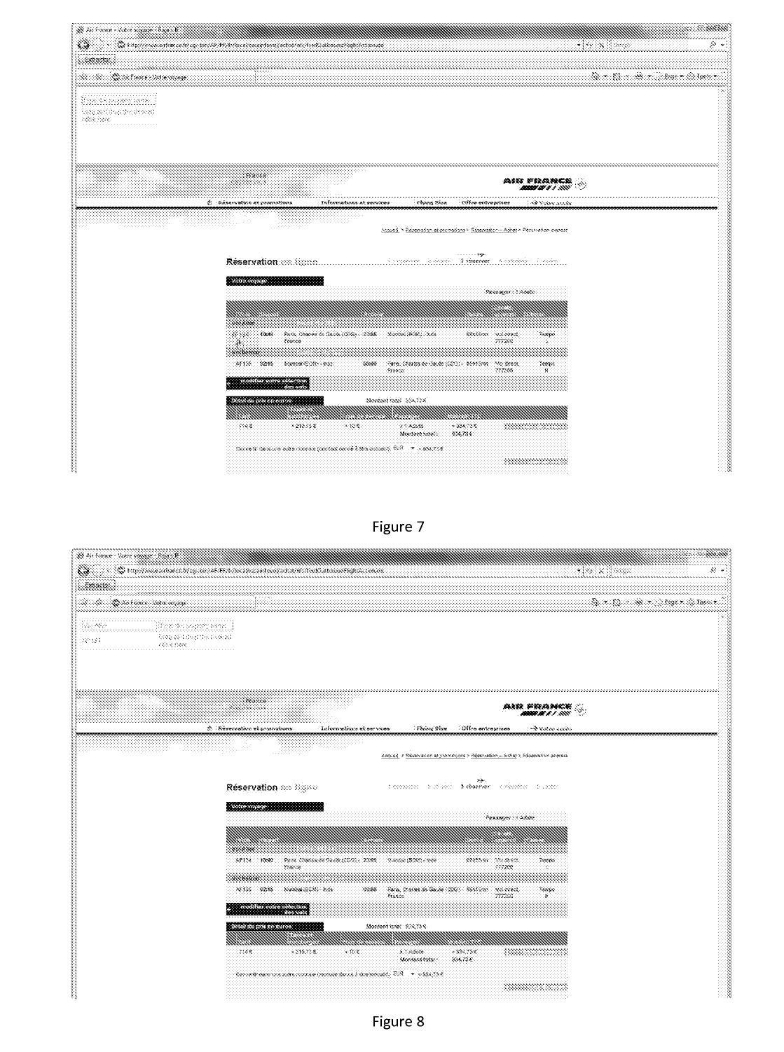

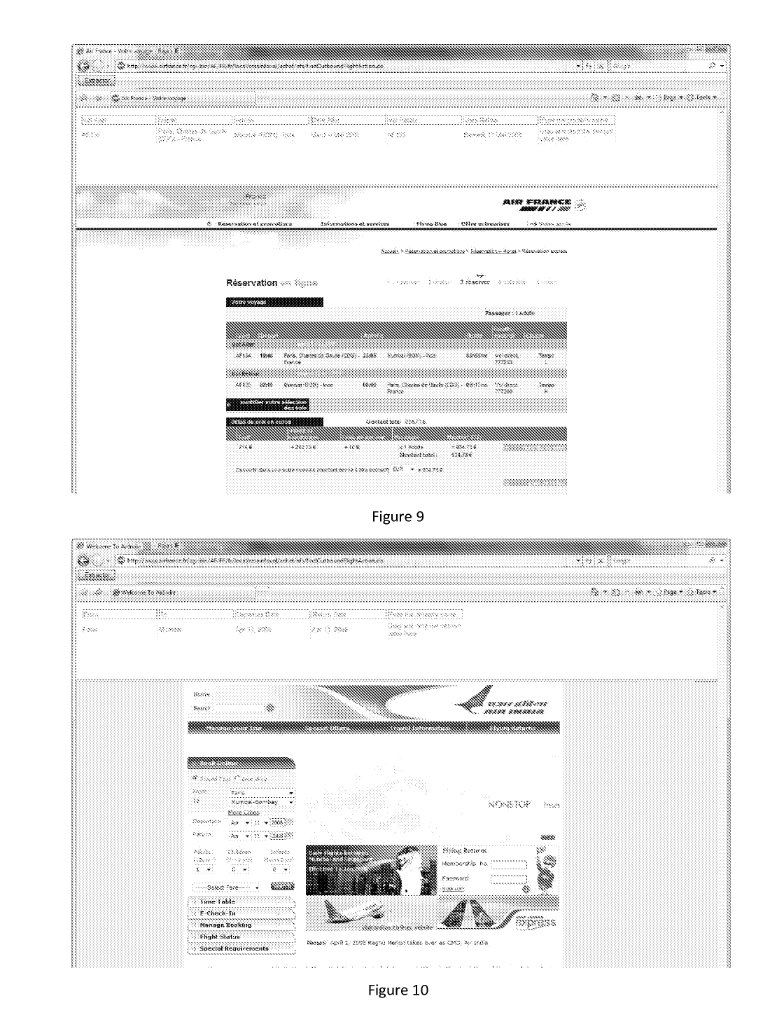

FIG. 7 presents a webpage presenting flights for which the user selects an attribute “One-way flight” to extract. FIG. 8 shows the fact that the extractor then creates the first column “One-way flight” of the extracted table, corresponding to this attribute. FIG. 9 presents the complete table thus built. FIG. 10 shows a table built according to the same method for another page of an airline company.

The synthetizer is the reverse of the extractor, it is created automatically at the time of the creation of the corresponding extractor, and makes it possible to post the data of a table in the style of presentation of the webpage, graphic zones being placed at the location of the objects containing the values of the table to make it possible to expand/collapse them and to drag-and-drop them to create a mapping as described further and illustrated in FIGS. 11 to 13.

It is created as follows: The user chooses an object model corresponding with a row of the table the one that has been used as model at the extractor creation time). All the objects corresponding to other rows of the table are withdrawn from the page and all the objects referred by objects corresponding to rows of the table but not by the object models are removed. The values contained in the object models are modified to correspond to the first row of the table, and a copy of the object is inserted after with the values each other row to display.⁹ ⁹An approach of implementation is the following one: let us call “synthesized object” the smallest object containing the model object as all the objects corresponding to an attribute of the model row (let us call these objects “attributes objects”), and let o1, o2, . . . , oⁿ the sequence of objects of which each one is parent of the following one, the first being the synthesized object and the last being the model object. A copy of the synthesized object is carried out, then (in the document itself) its attributes objects are modified to correspond to the first row displayed in the table. For each row of the table, is determined, in the synthesized object, the largest l (with 1≦l≦N) such as ol contains all the attributes objects corresponding to non empty cells of the current row. A copy of ol (and thus also of oJ for all the J>l) is created, its attributes objects are modified to reflect the current row, and it is inserted after (as sibling) the last copy of ol placed in the document. It should be noted that the user can request to modify a synthetizer. The same method above is then applied being based on a table of one row containing the names of the columns instead of values, with special marks making it possible to distinguish them from normal text (for example, “${author}” in the column author, and so on). The model object is located with special marks (for example <model-object> . . . </model-object>). The user can modify the resulting document with his own way, for example using a text editor, and returns it to the system. To display the synthesized page, the method above uses from now on this new structure (provided that there is exactly one zone delimited by the markers of model object). To note however that she is authorized to remove or duplicate markers of attributes. She can remove the display of an attribute which she considers not very important, and an example of duplication is to once place an attribute inside the model object and once outside, in order to have a heading using this attribute, while displaying the value of the attribute at each row of the displayed list. Another application is to put same “URL” value as both text and addresses of a hypertext link (i.e <a href=“$url”>$url</a>).

For a given synthetizer, with each column (posted at least once) can be associated the smallest of object (and thus largest l, with 1≦l≦N) containing all the markers with attributes corresponding to this column. This makes it possible to order the columns according to the importance being allotted them by the synthetizer (a small value of l indicates a higher importance). One can thus estimate a synthetizer up to what point is adapted for an order of deployment of columns, by comparing the order of deployment with the order of importance of these columns according to the synthetizer. When the system gives the list of the synthetizers for a given source, this list could be sorted according to this criterion, according to deployments already carried out by the user, in order to allow the selection of the synthetizer.

Mapping of Extractors

One now will illustrate creation by the user of a mapping between two preexistent extractors. FIG. 11 illustrates creation by the user of a mapping between two pages of an airline company for which extractors already exist. (Extractors for example having been built as illustrated in FIGS. 7 to 10). Having these two pages opened in two different tabs of the browser respectively, the user selects the option “Map with” to create a mapping between the current page and the other page.

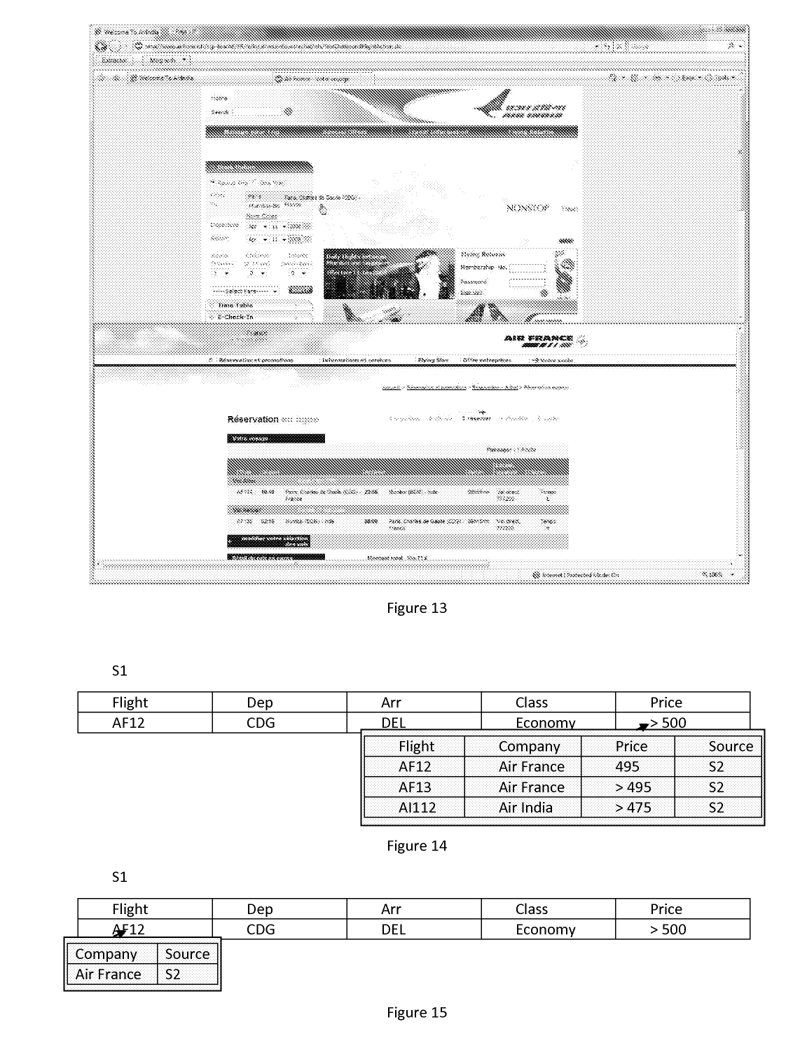

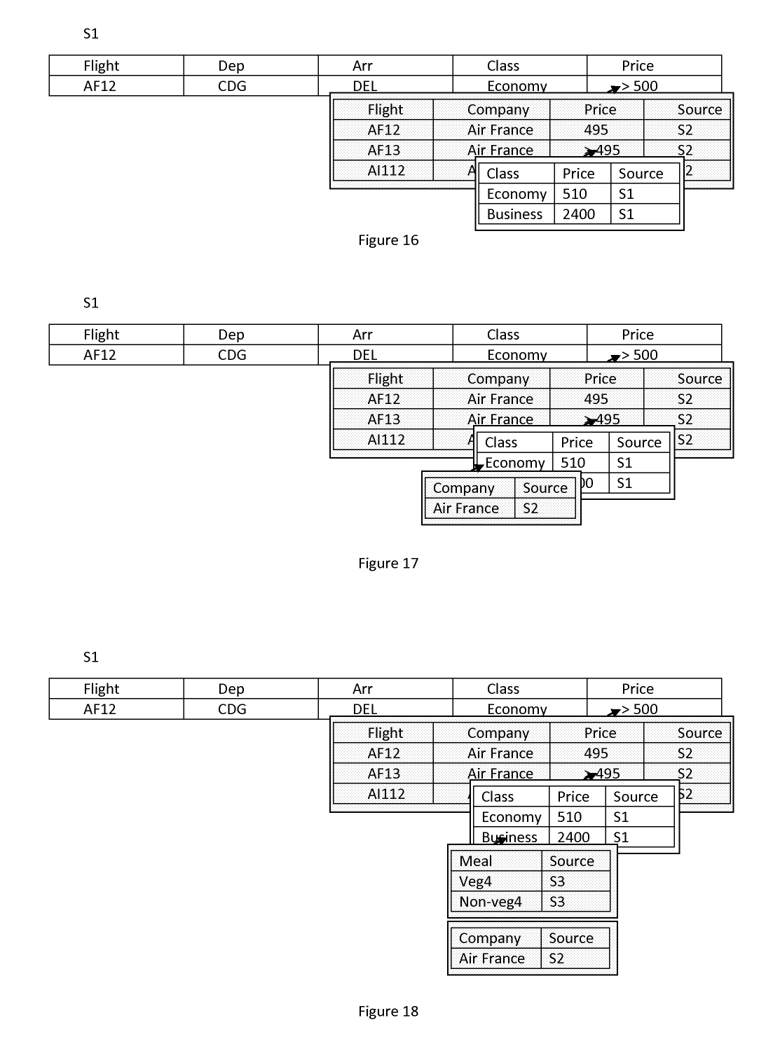

The two pages are then presented together (one below the other) and the user can thus map the attributes presented by the extractor for these two pages by simple drag-and-dropping (FIGS. 12 and 13). FIG. 12 shows taking the graphic object “Paris—Charles de Gaulle (CDG)” located in second half of the figure, and of drag-and-dropping it to the top of the figure. FIG. 13 shows dropping the dragged object, on the graphical object “Paris” located on first half of the figure.

### DESCRIPTION OF THE METHOD OF THE INVENTION

The following scenario will be used first to describe the basic method of the invention. The user accesses a first data source (S1) concerning flights of Paris (CDG) to Delhi (DEL) and filters on a given flight (AF12); a row presenting this flight is displayed (it is the “visible part” of S1). A second source (S2) whose mapping with the first source exists, is in the context and will enrich it. To facilitate comprehension it is supposed here that between S1 and S2 the names of attributes are the same and thus that the mapping is obvious here (and for the missing columns all their values are implicitly null). S1 and S2 have the following attributes:

| | | | | | | |
|---|---|---|---|---|---|---|
| S1: | Flight | Dep | Arr | | Class | Price |
| S2: | Flight | Dep | Arr | Company | (Class = Economy) | Price |

The respective filters of the sources are underlined. In S2 the Class column is missing but with the extractor of S2 a meta-data is associated to mean that the value of this attribute is always “Economy” (whatever the rows). Moreover for S2 it is given that the Flight attribute determines the Company attribute in functional dependency (FD). The initial data are the following:

S1 (Visible Part Only)

| Flight | Dep | Arr | Class | Price |
|---|---|---|---|---|
| AF12 | CDG | DEL | Economy | >500 |

S2 (Let us Suppose that there are Only these 4 Rows in S2)

| Flight | Dep | Arr | Company | Price |
|---|---|---|---|---|
| AF12 | CDG | DEL | Air France | 495 |
| AF13 | CDG | DEL | Air France | >495 |
| Al112 | CDG | DEL | Air India | >475 |
| XYZ | ABC | DEF | Another C . . . | 1234 |

In this example, the initial goal of the user is to obtain alternative offers for cities of departure (Dep) and of arrival (Arr) presented in the visible part of S1 and these are thus the attributes which constitute the filter (F) applied to S2.

For each row L in the visible part of S1, the method will first of all try to combine row R of S2 on the basis of at least one attribute filter F, here Dep and Arr (for S2). As one sees it in the Price column, in the columns, there can be precise values or domains of possible values.

Selection

To enrich the visible part of a first source S1 by a secondary source S2, at least one key attribute (or filter) F being given for S2 (or for the considered row R of S2) and the attribute map(F) of S1 corresponding to F by mapping, a row R of S2 is selected to enrich a row L of S1, if for the key attribute(s) F, the attribute(s) map(F) of S1 after transformation—if any transformation is required for the mapping—imply the attribute(s) F of S2, i.e. any value that map(F) can take can also be taken by F.

Alternative

An attribute A of a selected row R of S2 is alternative if
1. in L, the attribute map(A) corresponding to A is present (i.e. this attribute can have a non-null value or can take a value among a set of possible values, as opposed to the attributes not present in S1 and which thus necessarily have the default value Null) and
2. map(A) is potentially different than A (and preferably¹⁰ there does not exist in S1 a row L′ (other than L) where the value of map(A) is equal (i.e. is not potentially different) to the value of A). ¹⁰This last condition can be removed in the case of search for values in S1 alternative to S2, since the user does not access S2 directly but via the pop-up widget which is presented to her (see description further).

The Enrichment Method

For each row (L) of S1, when applying the filter¹¹ to S2 results in the selection of one or more rows (R) of S2 which comprise at least one alternative attribute, these rows are put—in the result (S1r)—in relation to the row L in question, with in addition optionally the information of their source (Source=S2). Thus the user can in particular visualize the union with L of the rows R which enrich it, presented for example as in the table S1r below according to which for each row R (having Source=S2) the column “Ref.” indicates the identifier (ID) of the row L with which it is thus put in relation: ¹¹Here it's about filtering S2 according to Dep (L) and Arr (L), L being the current row of S1 considered.

S 1r

| ID | Flight | Dep | Arr | Company | Class | Price | Source | Ref. |
|---|---|---|---|---|---|---|---|---|
| 1 | AF12 | CDG | DEL | Null | Economy | >500 | S1 | |
| 2 | AF12 | CDG | DEL | Air France | Economy | 495 | S2 | 1 |
| 3 | AF13 | CDG | DEL | Air France | Economy | >495 | S2 | 1 |
| 4 | AI112 | CDG | DEL | Air India | Economy | >475 | S2 | 1 |

This makes it possible to determine the rows of S2 to present to the user (for example in a pop-up widget, in the style of FIGS. 1 to 3 by means of the synthetizer which was already described) according to the attribute which she selects in a row of (the visible part of) S1: only the rows containing an alternative value for the selected attribute are presented to her. Thus, as FIG. 14 shows it schematically, when the user positions the mouse cursor on the representation of an attribute of L (here the Price attribute, this can be directly on the original page as depicted in the FIGS. 1 to 3) corresponding to an alternative attribute in one or more rows R (of S2 filtered according to the filter associated with S2 but having the values corresponding to this filter in L, here Dep=CDG and Arr=DEL), this (or these) attribute(s) is (are) presented to her spontaneously, with in addition optionally the indication of their source (Source=S2).

In parallel, if functional (FD) and/or multivalued dependencies (MVD) were defined for S2, they would make it possible to enrich the rows of the visible part of S1 and reciprocally the functional (FD) and/or multivalued (MVD) dependencies defined for S1 would make it possible to enrich the rows added by S2.¹² In this example, as it was defined for S2 that the Flight attribute determines the Company attribute in FD, this attribute is added in L (i.e. the value Null of the first row of S 1r is replaced by “Air France”): ¹²The rows which enrich are selected according to the definition (“Selection”) given in the previous page, here the key “F” being not the filter but the key (of respectively the functional and multivalued dependences) given.

S1r

| ID | Flight | Dep | Arr | Company | Class | Price | Source | Ref. |
|---|---|---|---|---|---|---|---|---|
| 1 | AF12 | CDG | DEL | Air France | Economy | >500 | S1 | |
| 2 | AF12 | CDG | DEL | Air France | Economy | 495 | S2 | 1 |
| 3 | AF13 | CDG | DEL | Air France | Economy | >495 | S2 | 1 |
| 4 | AI112 | CDG | DEL | Air India | Economy | >475 | S2 | 1 |

This last enrichment can be presented in a distinct way, as in FIG. 15 which presents the method in a schematic way (whereas the same information can be presented by means of the synthetizer already described).

The same method can be pursued in the reverse direction (i.e. from S2 to S1). It is supposed that S1 provides in addition the rows below (out of its visible part) for flights AF12 and AF13:

S1 (Except Visible Part)

| Flight | Dep | Arr | Class | Price |
|---|---|---|---|---|
| AF12 | CDG | DEL | Business | >2200, <2700 |
| AF13 | CDG | DEL | Economy | 510 |
| AF13 | CDG | DEL | Business | 2400 |

Let us recall that here the filter applied to S1 is the Flight column (it is the filter which was specified for this source) with the values of S2 for the attribute corresponding to this column. The method continues as follows:
If for a row of S2 appearing in S1r, there is in S1 at least another corresponding row (L′) comprising at least one alternative value, the said row is put in relation with the rows in question of S2, with possibly in addition the information of its source (Source=S1). The user can thus visualize a widened union comprising the rows in question of S1 and S2, presented as in the following table (here the rows L′ are slightly grayed to distinguish them) where, for each row L′ (having Source=S1) added, column ref. gives the identifier (ID) of the row R with which it is in relation;
Declared FD and/or MVD dependencies make it possible to enrich the sources on both sides. In fact, the FD of S2 makes it possible to enrich the new rows (of S1) added in S1r by providing the missing attribute Company.

S1r

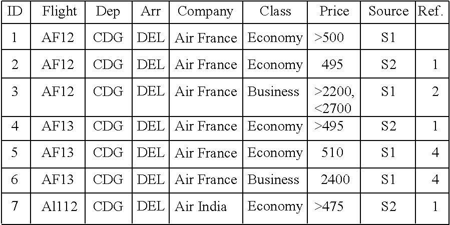

This makes it possible to determine the rows of S1 to present to the user according to the attribute selected in (directly as in FIG. 14, but still optionally via the synthetizer) in the pop-up widget which presents the rows of S2: only the rows of S1 containing an alternative value are presented to her. Thus, as FIG. 16 shows it schematically, when the user points by means of a pointing device (such as the mouse) the representation of an attribute of R (in FIG. 16, it is the Price attribute) presented as in FIG. 14, corresponding (for Flight=AF13) to an alternative attribute in (one or more) rows L of S1, these are presented to her spontaneously, with in addition optionally the indication of their source (Source=S1).

As shown in the FIG. 17, the functional dependencies of S2 according to which the key attribute Flight determines the Company attribute, makes it possible to enrich the row (among the last rows of S1 added in S1r) pointed by means of a pointing device.

Enrichment of a result of Enrichment

A result of enrichment can itself be enriched. Thus, if for example third source (S3) whose mapping with S1 or S2 is available (and is in the context), the method continues its execution. The sources have the following attributes in this example:

| | | | | | | |
|---|---|---|---|---|---|---|
| S1: | Flight | Dep Arr | | Class | Price | |
| S2: | Flight | Dep Arr | Company | (Class = Economy) | Price | |
| S3: | Flight | | | Class | | Legroom Airplane Meal |

Airplane depends on Flight in FD; Legroom depends on Flight and Class in FD; Meal depends on Flight and Class in MVD.

Insofar as the values of the Class attribute of S3 are the same ones as those given in S1 and S2 (for the corresponding Class attribute), and owing to the fact that the three other attributes (Legroom, Airplane and Meal) are missing in S1 and S2, no alternative row can be found in S3 compared to the rows of the result of enrichment (S1r) obtained up to now.

If one considered only the Airplane and Legroom attributes (if Meal was ignored), one would obtain following enrichments:

S1r

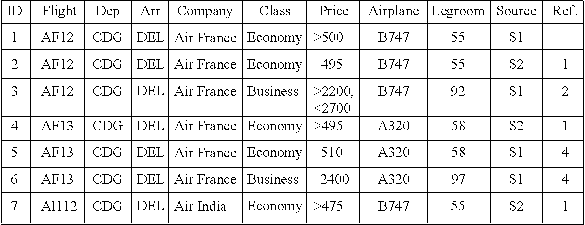

But as the Meal attribute is multivalued (Flight and Class determines Meal in MVD; indeed to each flight several dishes correspond, such as “Veg” and “Non-veg”, and this according to the respective classes), a row must be added for each additional value of Meal:

S1r

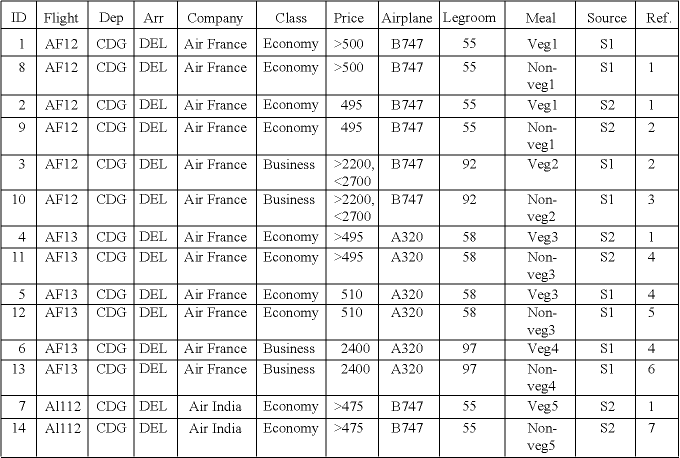

These last enrichments can be presented in a distinct way, as on FIG. 18:

As already mentioned, the contents of the pop-up widgets schematically presented in FIGS. 14 to 18 can be generated by a synthetizer (described before) to benefit from the original presentations of the respective sources (as shown in FIGS. 1 to 3). Two enrichments (respectively by S3 and S2) presented schematically on FIG. 18 can be presented in two distinct tabs from same a pop-up widget, each tab having as labels the source (S2 or S3) in question and presenting its contents as in the original source (as in the graphic style of FIGS. 1 and 2).

Addition of Rows Having a Reference to a Row of Enrichment

Each row of S2 (resp. S1), which has at least one attribute having at least one direct or indirect reference to at least one row of S2 (resp. S1) which was added in S1r, is added (in S1r) in its turn. It is however not added in case of inconsistency of the set of the involved constraints. Adding it involves the continuation of the method described up to now, as now described by extending the same scenario considered up to now.

Thus let us take again the same example with S1 and S2, and add the attributes hour of departure (DepT) and hour of arrival (ArrT), which are in functional dependency of Flight,

| | | | | | |
|---|---|---|---|---|---|
| S1: | Flight | Dep Arr | DepT ArrT | | Class Price |
| S2: | Flight | Dep Arr | DepT ArrT | Company | (Class = Economy) Price |

As well as two rows in S2:
a flight AF14 which awaits at DEL the arrival of flight AF12, its departure for Singapore (SIN) being envisaged 1:00 hour after the arrival of flight AF12 and its arrival to SIN being envisaged 3 hours later;
and a flight AF15 which awaits at DEL the departure of flight AF14, its departure for SIN being envisaged 2:00 hours after the departure of flight AF14 and the arrival at SIN being envisaged 3 hours later.

The data are now the following ones:

S1 (Visible Part Only)

| Flight | Dep | Arr | DepT | ArrT | Class | Price |
|---|---|---|---|---|---|---|
| AF12 | CDG | DEL | 10 | NULL | Economy | >500 |

S2 (Let us Suppose that there are Only these 6 Rows in S2)

| | A | B | C | D | E | F | G |
|---|---|---|---|---|---|---|---|
| | Flight | Dep | Arr | DepT | ArrT | Company | Price |
| 1 | AF12 | CDG | DEL | NULL | =D1 + 13 | Air France | 495 |
| 2 | AF13 | CDG | DEL | 8 | 21 | Air France | >495 |
| 3 | AF14 | DEL | SIN | =E1 + 1 | =D3 + 3 | Air France | 250 |
| 4 | AF15 | DEL | SIN | =D3 + 2 | =D4 + 3 | Air France | 250 |
| 5 | AI112 | CDG | DEL | 11 | 24 | Air India | >475 |
| 6 | XYZ | ABC | DEF | 1 | 2 | Another | 1234 |
| | | | | | | comp. | |

The cells of S2 have each one an identifier made up of the letter of the column and number of row, as in a spreadsheet. One sees that for example the D3 cell contains a formula “=E1+1”, as in a spreadsheet, which is here a constraint of equality (D3=E1+1).

One supposes in this example that rows 3 and 4 of S2 cannot be enriched (by functional dependency) by any row of S1 (S1 not providing any row with Flight AF14 or AF15).

The enrichment of S1 by S2 will result in a table S1r as below, the rows in gray being the alternative rows of S1 (as in the previous example), and the seventh and eighth rows (corresponding to rows 3 and 4 of S2) being now added owing to the fact that they have (directly or indirectly) a reference to the second row of S1r (corresponding to row 1 of S2):

S1r

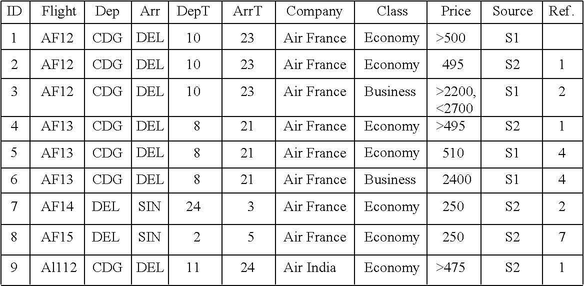

Indeed, although not corresponding to the filters Dep=CDG and Arr=DEL, rows 3 and 4 of S2 belong to the set of relevant rows for the user because they have a reference to at least one row (of S2) enriching S1. It should be noted that if in S1 there are rows having a reference to rows added in S1r whose Source is S1, they are also added in S1r, and then new rows from S2 (alternative or complementary to them) are added in their turn (insofar as they are not invalidated by functional dependences of S1), and so on.

However, if later in this same scenario, S1 provides in addition the row below

S1 (Except Visible Part)

| Flight | Dep | Arr | DepT | ArrT | Class | Price |
|---|---|---|---|---|---|---|
| AF15 | DEL | SIN | 1 | 4 | Economy | 250 |

then, because of the fact that the Flight attribute determines the DepT attribute in FD, row 8 of S1r is invalidated (row 4 of S2 cannot enrich S1 more), because the current set of constraints (D3=E1+1, D4=D3+2, etc) which results in D4=2 is inconsistant with D4=1, and row 4 of S2 depends on this constraints owing to the fact that it has a reference to row 3 (D4=D3+2). S1r would then only contain the following rows:

S1r

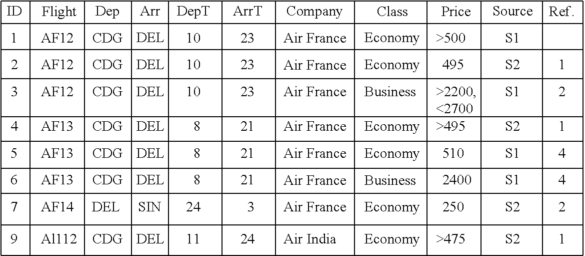

Obviously, if another row still had a reference to the row 8 which was invalidated, it is also withdrawn from S1r.

Temporal Meta-Attributes

One can memorize various enrichments carried out in time and compare them, thanks to two temporal meta-attributes: BS (Belief Start, or “Valid since”) and BE (Belief End, or “Valid until”).

Let us suppose that the first enrichments above (before the provision of flight AF15 by S1) took place at time 1 and that the last enrichment following the addition in S1 of flight AF15 took place at time 3. S1r is then as follows. One sees that rows 7 and 8 are not valid any more, considering that their meta-attribute BE has the value 3:

S1r

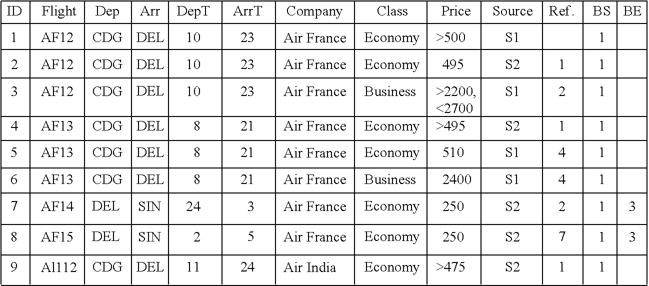

Obviously, these meta-attributes can be hidden to the user, withon the condition of also hiding the rows which are not valid at the considered date (here called “wall-clock time”). This approach makes it possible for the user to be positioned on a wall-clock time date in the past and to see the data of enrichment (S1r) valid on that date. For example, when the user positions herself at the wall-clock time date=2, she again sees the following table (which was shown higher):

S1r

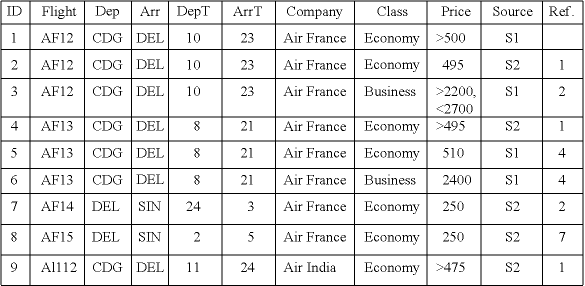

whereas when the user positions herself at Wall-clock time=NOW (after time 3) rows 7 and 8 are withdrawn. Tis is achieved in taking in S1r only the rows whose Wall-clock time lies between BS and BE.

Several enrichments can thus be visualized (and compared) while varying the variable Wall-clock time (for example by means of a temporal slider). Now let's see another scenario where various rows can be gathered according to a given criterion, and to certain aggregated attributes, and in which this possibility of comparing several sets of enrichments is advantageous.

### EXAMPLE

The sources that we use here have the following attributes:
S1: Group Country Dates Price
S2: Group Country Dates Price Scenario

Each row of these sources concerns say an action of a given Group, carried out in a given Country, at a certain Date for a certain Price.

The Date attribute from S2 is specified as having the type “Real-time”, which means that this attribute represents the date of real occurrence of the data to be enriched, which makes it possible to have the Date constraint “>NOW” when it is tentatively added in the result because of a reference from (or towards) another row added in the result, as long as it is not combined with the other source (which would then give it its real date of occurrence).

In S1 and in S2, Group and Country determine the Date and Price attributes in FD. The data are the following ones:

S1 (Visible Part Only)

| Group | Country | Date | Price |
|---|---|---|---|
| A | FR | March 2008 | 100 |

S2 (Let us Suppose that there are only these 6 Rows in S2)

| | A | B | C | D | E |
|---|---|---|---|---|---|
| | Group | Country | Date | Price | Scenario |
| 1 | NULL | FR | NULL | NULL | NULL |
| 2 | =A1 | PCT | ≦C1 + 12, >C1, <C3, | >150, <170, | Sc1 |
| | | | default: C1 + 12 | Default: 160 | |
| 3 | =A2 | EP | ≦C2 + 10, | >140, <160, | Sc1 |
| | | | default: C2 + 10 | Default: 150 | |
| 4 | =A1 | EP | ≦C1 + 12, >C1, <C5, | >140, <160, | Sc2 |
| | | | default: C1 + 12 | Default: 150 | |
| 5 | =A4 | IT | ≦C4 + 8, | >70, <90, | Sc2 |
| | | | default: C4 + 8 | Default: 80 | |

S2 is used here to specify scenarios; each scenario is a model of prediction in time for a group (Group) of actions given. Thus one sees, in the Date attribute from the rows of S2, constraints of sequence (such as C2>C1, C2<C3) between rows, with maximum durations between them (such as C2≦C1+12), as well as data by default (such as default:C1+12) to be presented to the user in the result, when the date in question is not instantiated. The Price column also contains constraints and default values.

As the attributes Group and Country determine the Date and Price attributes in FD, the first row of S2 can unify here with the first row of S1¹³ and bring with it the other rows of S2 which have a direct or indirect reference of it: ¹³By “As the attributes Group and Country determine . . . ” one understands the following: To determine if the functional dependency specified for S2 (“Group and Country determine the Date attributes and Price in FD”) can be exploited, the method checks if the attributes in S1 corresponding to Group and Country of S2 imply the latter, i.e. for all their potential values in the row considered of S1, these attributes take also these values in the row considered of S2. Actually, the second one was given in a instantiated way (and not in the form of domain), and this checking thus returns a simple test of equality, and implication of NULL always succeeds. By “ . . . determine the Date and Price attributes in FD, the first row of S2 can unify here with the first row of S1 . . . ” one understands the following: The constraints given respectively on these attributes in the first row of S2 are added to the set of constraints for the respective corresponding attributes of the row in question of S1.

S1r

| ID | Group | Country | Date | Price | Scenario | Source | Ref. |
|---|---|---|---|---|---|---|---|
| 1 | A | FR | March 2008 | 100 | | S1 | |
| 2 | A | PCT | Default: March 2009, >NOW | Default: 160 | Sc1 | S2 | 1 |
| 3 | A | EP | Default: January 2010, >NOW | Default: 150 | Sc1 | S2 | 2 |
| 4 | A | EP | Default: March 2009, >NOW | Default: 150 | Sc2 | S2 | 1 |
| 5 | A | IT | Default: November 2009, >NOW | Default: 80 | Sc2 | S2 | 4 |

The constraints “>NOW” were added for the Date attribute owing to the fact that this attribute is of type “Real-time” and that these rows are not enriched yet by a row by S1.

Later, let us suppose that S1 provides in addition the row below

S1 (Except Visible Part)

| Group | Country | Date | Price |
|---|---|---|---|
| A | EP | February 2009 | 155 |

This then allows to infer (by FD)¹⁴ that the date of rows EP is 02/2009. However current time (NOW) being now necessarily higher than 02/2009 (since the Date attribute from row EP corresponds to the insertion of this row in “real-time”) and the Date of the second row of S1r having to be higher than NOW (according to the constraint “>NOW”), it must be higher than 02/2009, and consequently the second row comes in time after the third (of which the Date is equal to 02/2009), which contradicts constraint C2<C3 given in the Date column from the second row. Consequently the second and third rows are invalidated and in S1r there remains nothing any more but the first, the fourth and the fifth row. The fourth row is in addition enriched in FD to specify its values Date and Price (given in FD). Moreover, the new row of S1 is added (ID=6 in the table) as an alternative data to row 4 of S2. ¹⁴ (i.e. enriching S2 by S1, thanks to the FD according to which Group and Country determine Date and Price)

S1r

| ID | Group | Country | Date | Price | Scenario | Source | Ref. |
|---|---|---|---|---|---|---|---|
| 1 | A | FR | March 2008 | 100 | | S1 | |
| 4 | A | EP | February 2009 | 155 | Sc2 | S2 | 1 |
| 6 | A | EP | February 2009 | 155 | | S1 | 4 |
| 5 | A | IT | Default: November 2009, >NOW | Default: 80 | Sc2 | S2 | 4 |

Lastly, the method can comprise a last step which (optionally) unifies the rows of S1r that can be unified (i.e. when combining their respective constraints does not lead to an inconsistency), here the rows 4 and 6:

S1r

| ID | Group | Country | Date | Price | Scenario | Source | Ref. |
|---|---|---|---|---|---|---|---|
| 1 | A | FR | March 2008 | 100 | | S1 | |
| 6 | A | EP | February 2009 | 155 | Sc2 | S1 | 1 |
| 5 | A | IT | Default: November 2009, >NOW | Default: 80 | Sc2 | S2 | 6 |
| Total | | | | 345 | | | |

It is easy to calculate the total of the Price as illustrated in the last row of the table above.

If the meta-attributes BS and BE are used, by supposing that the first data were inserted at time 1 and that the new data were inserted at time 3 (S1 having provided a row “EP” at time 3, like below),

S1 (Except Visible Part)

| Group | Country | Date | Price | BS | BE |
|---|---|---|---|---|---|
| A | EP | February 2009 | 155 | 3 | |

S1r is as follows:

S1r

| ID | Group | Country | Date | Price | Scenario | Source | Ref. | BS | BE |
|---|---|---|---|---|---|---|---|---|---|
| 1 | A | FR | March 2008 | 100 | | S1 | | 1 | |
| 2 | A | PCT | Default: March 2009, | Default: 160 | Sc1 | S2 | 1 | 1 | 3 |
| | | | >NOW | | | | | | |
| 3 | A | EP | Default: January 2010, | Default: 150 | Sc1 | S2 | 2 | 1 | 3 |
| | | | >NOW | | | | | | |
| 4 | A | EP | Default: March 2009, | Default: 150 | Sc2 | S2 | 1 | 1 | 3 |
| | | | >NOW | | | | | | |
| 6 | A | EP | February 2009 | 155 | Sc2 | S1 | 1 | 3 | |
| 5 | A | IT | Default: November 2009, | Default: 80 | Sc2 | S2 | 6 | 1 | |
| | | | >NOW | | | | | | |

Thus, if one positions the Wall-clock time at time 2 and wishes to see the prediction made at that time, one sees the following table S1r (where row 6 did not exist yet), obtained by filtering on the rows having the time 2 ranging between BS and BE (for row 6, the BS was equal to 3):

S 1r

| ID | Group | Country | Date | Price | Scenario | Source | Ref. |
|---|---|---|---|---|---|---|---|
| 1 | A | FR | March 2008 | 100 | | S1 | |
| 2 | A | PCT | Default: March 2009, | Default: 160 | Sc1 | S2 | 1 |
| | | | >NOW | | | | |
| 3 | A | EP | Default: January 2010, | Default: 150 | Sc1 | S2 | 2 |
| | | | >NOW | | | | |
| 4 | A | EP | Default: March 2009, | Default: 150 | Sc2 | S2 | 1 |
| | | | >NOW | | | | |
| 5 | A | IT | Default: November 2009, | Default: 80 | Sc2 | S2 | 6 |
| | | | >NOW | | | | |

The presentation of the results can allow the selective expand/collapse of rows of S1 (resp. S2) and the rows of S1r are then expanded/collapsed consequently. When rows of S1 (resp. S2) gather a plurality of rows and aggregate their values, S1r aggregates the enriched rows the same way.

Addition of Rows to Which Rows of Enrichment have a Reference

The case of the rows of enrichment having a reference to other rows which are conditions is described in the following example:

The sources which one will use have the following attributes:
S1: Person Parent
S2: Person Sibling Parent

The attributes are a Person, her Sibling, her Parent.

In S2, Person determines Sibling and Parent in MVD.

The data are the following ones:

S1 (the persons A and B have both C as Parent)

| Person | Parent |
|---|---|
| A | C |
| B | C |

S2 (two people which has the same Parent are brothers).

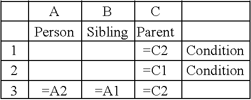

One introduces here a new concept, that of the rows “Conditions”. They are the rows having “Condition” in last column (grayed in the table above).

In a sense, the Conditions rows have the role of widened key, i.e. all their columns must be implied by rows of the other source to allow the referring rows to be eligible to enrich the other source.

At the time of the method of addition in S1r of an alternative row of S2 (resp. S1), or of enrichment in FD or MVD by a row of S2 (resp. S1), the Condition rows of S2 (resp. S1) are first of all ignored, then those of which the said row of S2 (resp. S1) refers to are taken into account (and so on, by “backward chaining”), but provided that all their attributes are implied by the attributes of the corresponding rows in S1 (resp. S2) and of course that the set of constraints is consistent.

Thus, in this example, row 3 of S2, which makes it possible to enrich in MVD each row of S1, brings with it all the cases of combination of Conditions rows implied by corresponding rows in S1. This gives:

S1r

| ID | Person | Sibling | Parent | Source | Ref. |
|---|---|---|---|---|---|
| 1 | A | B | C | S1 | |
| 2 | B | | C | S2 | 1 |
| 3 | A | | C | S2 | 1 |
| 4 | B | A | C | S1 | |
| 5 | A | | C | S2 | 4 |
| 6 | B | | C | S2 | 4 |

Lastly, the same method of unification of rows of S1r presented with the previous example makes it possible to unify rows 3 and 5 with row 1, as well as rows 2 and 6 with row 4:

S 1r

| ID | Person | Sibling | Parent | Source | Ref. |
|---|---|---|---|---|---|
| 1 | has | B | C | S1 | |
| 4 | B | has | C | S1 | |

Thus, enrichment by S2 makes it possible to add in S1 the missing values for the attribute Sibling (respectively B and A) of Person (respectively A and B).

The implementation of the method is now described, knowing that the cases seen in the examples can be mixed, for example rows can have references towards rows which are used to enrich (as in the example of the flights and also in the example of the planning of actions), while having references on Conditions rows.

Implementation

The non-determinism (the combinatorics of the possible rows to be added to S1r) which is inherent in the method of enrichment in the presence of constraints having references between rows, can be treated by the recursive approach described below. All rows of the visible part S1v and all the alternative rows candidates of S2 (then of S1), as well as their constraints (classically implemented as “solver:tell”¹⁵ instructions), being already introduced into S1r insofar as their constraints do not generate inconsistency, the enrichment of the respective rows of S1 (resp. S2) will be in the following approach: ¹⁵(consisting of adding/propagating the constraint in question in the set of the constraints)

foreach L in S1v rows or in alternative S1 rows...

| | |
|---|---|
| foreach R in S2 | ignoring Condition rows |

```
        foreach FD (FD:KeysS2->Cols)  (same approche for MVD alternative rows)
            solver: push mark
            if solver: (Map(KeyS2(L)) =>¹⁶ KeyS2(R)) for all KeyS2 in KeysS2
                solver:tell's (Map(KeyS2(L)) = KeyS2(R)) for all KeyS2
                if (do solver:tell's to merge in L the FD Cols of R)
                    Determine ReferredRows by transitive closure
                    CheckReferredRows(ReferredRows,{ },L,R)
            Solver: undo(i.e. undo the solver:tell since the last“solver:push mark”)
¹⁶This test can be omitted if the attributes Map(KeyS2(L)) and KeyS2(R) are instantiated, since the test solver:tell (Map(KeyS2(L)) = KeyS2(R)) is added just after (and since if the first fails, the second one fails too). A test X1 Op Exprl => X2 Op Expr2 comes to detecting Store U { X1 Op Expr1 } I = X1 Op Expr2 (the Store is the current set of constraints). This is equivalent to Store U { X1 Op Expr1 } U { X1 -Op Expr2 } is inconsistent.
```

The rows R of S2, likely to enrich by FD the rows L of S1, being thus found (above), it is necessary to check for each R that its Conditions rows (in S2), if any, have correspondents in S1, it is then necessary to add the other rows to which R refers, if any, as well as the rows having a reference to R, and to use them to enrich the rows L by their FD, MVD and alternative rows:

CheckReferredRows(ReferredRows, AccumulatedRows, L, R) {
if (ReferredRows is empty)

| | |
|---|---|
| add L to S1r (if L is not NULL) | (L is already enriched by FD columns) |

```
    foreach X in AccumulatedRows
        add X to S1r
        foreach R′ = row referring X  (if X is from S2 and L is not NULL)
            CheckReferringRow(R′)
    foreach MVD (MVD:KeysS2->Cols)
        solver : push mark
```

| | |
|---|---|
| if solver: (Map(KeyS2(L)) => KeyS2(R)) | for all KeyS2 in KeysS2 |

create L′ from L with all cols of L except MVD Cols which are taken

| | |
|---|---|
| from R | (L′ is built with solver:tell) |

```
            add L′ to S1r
        Solver : undo
    foreach R′ = row referring R
        CheckReferringRow(R′)
else
    let R′ be the 1st row of ReferredRows
    if R′ is a Condition row
        foreach L′ in S1
            solver: push mark
```

| | |
|---|---|
| if solver: (Map(Col(L′)) => Col(R′)) | for all the columns |
| solver:tell's (Map(Col(L′)) = Col(R′)) | for all the columns |

```
                if (do solver:tell's to merge in L′ the FD Cols of R′) then
                    CheckReferredRows(ReferredRows − {R′}, AccumulatedRows
                    + {L′}, L, R)
            solver: undo
```

| | |
|---|---|
| else | (R′ isn't a Condition) |

```
        found = false
        foreach L′ in S1
            solver: push mark
            if solver: (Map(KeyS2(L′)) => KeyS2(R′)) for all KeyS2 of FD:KeysS2 (and
                found = true  same approach for the MVD and the alternative rows)
                solver:tell's (Map(KeyS2(L′)) = KeyS2(R′))  for all KeyS2
                if (do solver:tell's to merge in L′ the FD Cols of R′) then
                    CheckReferredRows(ReferredRows − {R′}, AccumulatedRows
                    + {L′}, L, R)
            solver: undo
        if (found = false)
            solver: push mark
            if (solver:tell constraints of R′)
                foreach col X that has type “real-time”
                    solver:tell X > now
                    CheckReferredRows(ReferredRows − {R′}, AccumulatedRows
                    + {R′}, L, R)
            solver:undo
```

The following function is primarily used to add in S1r each ReferringRow row which would have a reference to a row found until here (after having checked the consistency of its constraints):

```
CheckReferringRow(R′) {
found = false
foreach L′ in S1
    solver: push mark
    if solver: (Map(KeyS2(L′)) => KeyS2(R′))  for all KeyS2 of FD:KeysS2 (and
        found = true  same approach for the MVD and the alternative rows)
        solver:tell's (Map(KeyS2(L′)) = KeyS2(R′))  for all KeyS2
        if (do solver:tell's to merge in L′ the FD Cols of R′) then
            Determine ReferredRows by transitive closure
            CheckReferredRows(ReferredRows,{ },L′,R′)
    solver: undo
if (found = false)
    solver: push mark
    if (solver:tell constraints of R′)
        foreach col X that has type “real-time”
            solver:tell X > NOW
        Determine ReferredRows by transitive closure
        CheckReferredRows(ReferredRows,{ R′},NULL,R′)
    solver:undo
```

The algorithm above gives the method to cumulate the constraints and to keep only the consistent sets of rows. It can easily be extended to detect the alternative rows and to enrich them as described in all detail. The professional knowing the art of the constraint solvers now has all the elements to implement the method of enrichments and of unifications describes up to now and to integrate into it constraint solvers (such as on reals, integers, booleans, strings, lists, etc) of the state of Art.

Context

The context is the set of the S2 sources to be taken into account to enrich S1 (insofar as a mapping with S1 is available for them). The context is configurable by the user and can in particular include the pages appearing in the same instance of the web browser and/or the most recently accessed pages, sorted according to their contents and/or their meta-data.

The selection of the sources of the context to enrich an accessed current source, can take account of information of “local context” such as geolocation, which will be used as criteria to select S2 sources according to their meta-data or their content.

The said selection of course takes also account of the content of the sources composing the context of the user herself or his “close relations”, the said proximity including criteria of geographical proximity, the relations explicitly given and/or counting of the effective usage of mappings as described hereafter.

Determining the selection of mappings to suggest to the user can be computed as follows.

Local storage: when a user creates a mapping between two extractors, this is proposed first. When a user used a mapping once, it would gain to be proposed again. So for each user all mappings which she (recently) used must be stored.

Usage counting: When many users used a mapping it would gain to be proposed to all the users. One gives as “score” to a mapping the number of times that it has been applied, then one proposes only mappings highest having the score. The server stores a table thus containing the number of usages for each mapping.

Counting of “refusal”: When many users reject a suggestion it would gain to stoped being proposed automatically automatically.

So the score of a mapping can now be calculated according to an expression such as S (U, R, S)=Min(U−R, K*U/S) (U number of usages, R number of rejections and S number of suggestions; K constant). The server stores a table thus containing these three numbers for each mapping.

Taking the values into account: Using a mapping counts more if one or more mapped columns put have the same value as in the current case. To store server side a table (source page, identifier of mapping, identifier of Filter or Key column, source values, number of mappings, number of suggestions). When there is only one column of Filter, the counter for the corresponding row is incremented. When there are several columns of Filter, each column-value pair has its own counter and all are incremented independently. In order to prevent that this table becomes too large, the rows having the smallest frequencies of usage are removed (the frequency being the ratio of the usage counter and the time of existence of the row in the table)

To take account of this information, the following addition is carried out sv(U . . . , R . . . , S . . . )=s(U, R, S)+max(0, S (U′, R′,))+max(0, S (U″, R″,′))+ . . . , with a term for each column of Filter and a term independently of the values (U′, R′ and etc. are defined as U, R and S, but by counting only the times where the value corresponded).

To take account of the proximities of the other users: if two users are close one supposes that they will want to establish same mappings, and thus one can weight their usage, creation and rejection counters with the proximities with the current user. The proximity between two users can in particular be calculated by comparing the differences between the sets of mappings that they used. A complete list of the mappings carried out by a certain number of “representative” users will thus be stored in the server. When the number of users is reduced, they all are considered representative. When it increases, one seeks a pair of users very close one to the other and withdraws one from the set of representative users. One stores for all the users their proximities with all the representative users. A user is considered near to another if their vectors of proximity to the representative users are close (the proximity p (t, u) of two users t and u is 1/Σ (ti-ui)², where ti is the proximity of t to the representative user i. The latter is obtained by the ratio between the number of mappings used jointly (intersection) on the number of total mapping used by the two users (union)). This being known, the client part of a user can be connected directly to the close users, and calculate for each one the score of various mappings by holding account only usages, suggestions and rejections for this user, then to carry out a weighted average by the proximity of this user: st=sv (U . . . , R . . . , S . . . )+p1*sv (U1 . . . , R1 . . . , S1 . . . )+p2*sv (U2 . . . , R2 . . . , S2 . . . )+ . . . , where p1, . . . , pN are positive numbers having 1 as total and corresponding to the proximities of the close users, “Ui . . . ” represent Ui, Ui′, Ui″, . . . and represents the numbers of usage U, U′, U″, . . . etc, concerning user I, and similarly for R and S.) In order to discharge the server (and to limit the quantity of data provided to the server by the users) one can, when a sufficient number of close users are known for a given user, ignore the global term sv(U . . . , R . . . , S . . . ).

Each user thus stores the set of his close users, that it requests from the server at regular intervals (actually, this set can change during time. For example when a user was not seen online during too a long time one can withdraw it from all the set of close users, and it is then necessary to find new users “to replace it”).

To preserve the anonymity of the users, several solutions are possible:
The users do not connect themselves directly to their close users but make transfer all the traffic to the server.
The previous method makes it possible to the server to know all the data. One can cure that by encrypting all the data (all the users would thus have an private key unknown by the server, and a public key accessible to all the users by the identifier from the corresponding user).
As this solution can load the server, the following protocol can be used: A wants to contact B. A sends the identifier of B to the server. The server chooses a user I different from A (ideally I will be a user known to have a good bandwidth and who is not already engaged in this protocol with other users). The server provides to I the IP addresses of A and B with a connection number, thus informing I that it has been selected as intermediary. The server sends to A the address of I and the identifier of connection. The machine A sends the data to I, which can then relay it to B without A knowing the IP address of B, and without I knowing the user identifier of B (he onlyknows his IP address).

It should be noted that, whatever the strategy used, a close user not being online at the execution time of the algorithm will not be consulted. It is thus necessary to hold up to date a sufficiently large set of close users so that at any moment, a sufficient number is available.

Transitivity (carried out client side): when a mapping A-B is proposed and B would propose a mapping B-C, one may want to propose A-C directly. The score of such a chain of mappings is obtained by multiplying the scores of the elements of the chain and by dividing by M̂(n−1), where M is the greatest score sv met (among all mappings considered) and n is the number of elements in the chain. This is equivalent to calculate s1*s2/M*s3/M* . . . , where each factor except the first is smaller than or equal to 1 (M being the maximum of the scores met), and the set of “si” traverses the set of the scores of the elements of the chain. The score is thus smaller or equal to the score of all the elements of the chain, and the score of a chain of length 1 is precisely the score of the single element that it contains. Two chains having the same ends and whose combination of mappings of columns provides the same result are considered equivalent, and in this case only one chain is proposed, that whose score is highest.

### EXAMPLES

Thus of new data sources can be combined automatically by default, provided that they were already (mapped and) combined previously. For example, a user creates herselves a data source named “Vendeur2” (for example starting from an already existing source, here starting from “Vendeur1”) and presents the sales offer for a book “Author1” “Title1” (for example a used book which he would like to resell). Another user who accesses “Vendeur1” takes note of the offer of “Vendeur2” by the simple fact that a relatively large number of other users already combined “Vendeur2” with “Vendeur1” and put their respective columns in correspondence.

A selection criteria can be meta-attribute BS (Belief Start, “Valid Since”) already described, representing the time of first appearance of the row.

If the offer of “Vendeur2” is most recent, the said other user will see the offer of “Vendeur2” instead of the offers of the other salesmen; if not, she will be able to see it while moving in the past (by moving a temporal cursor “Wall-clock time”). In this approach of combinations by default, a graphical means will be offered to the user to make disappear from the display the values coming from a combined source, i.e. to reject the combination in question, or to undo a mapping of columns carried out by default, and these rejections are entered in the countings, as described above, to influence the determination of the suggestions.

In a more refined approach, as described earlier, the presented data itself can be taken into account in the countings. Let us mention the example above with “Vendeur2” and specify it further. The user who accesses “Vendeur1” will not take note of the offer of “Vendeur2” in all the cases, but only if “Author1” “Title1” is presented to her (in the presentation of “Vendeur1”), because it is precisely when “Author1” “Title1” was presented to them that a relatively large number of other users had combined “Vendeur2” with “Vendeur1” (and not when they visualized data on any other books). Thus, the said countings can moreover take into account the data visualized by the user during the combinations.

Here a more complete example: An extractor provides a data source “Yamazuki” extracting the data from the website of the large motor bike manufacturer Yamazuki which presents all the motor bikes of this brand, with all their characteristics.

Yamazuki

| Type | | | |
|---|---|---|---|
| of motor bike | Caracteristics . . . | Valid since | Valid until |
| RS750 | — | March 20th, 2007 10:00 | Null |
| — | | | |

A private individual publishes a data source “I sell” containing a row presenting the type of motor bike (as key value), the details, the price and the place of sale of a recent Yamazuki motor bike (which she puts on sale).

I Sell

| Type of | | | | | Valid |
|---|---|---|---|---|---|
| motor bike | Details . . . | Price | Place | Valid since | until |
| RS750 | — | 5000 | Fontainebleau | March 23rd, | Null |
| | | | | 2007 17:00 | |

Then, herself and/or other(s) user(s) combine this source “I sell” with the source “Yamazuki”, by mapping the columns which identifies the exact type of the motor bike put on sale.

Yamazuki+I Sell

| Type of motor | | | | | | Valid |
|---|---|---|---|---|---|---|
| bike | Caratéristiques . . . | Details . . . | Price | Place | Valid since | until |
| RS750 | — | — | 5000 | Fontainebleau | March 23rd, 2007 | Null |
| — | | | | | 17:00 | |

When an end user will visit the site of Yamazuki and visualize the data about the type of motor bike which is the one that the private individual put on sale, the offer of the private individual will only be presented to her spontaneously if the number of times that “I sell” was combined with “Yamazuki” is relatively important.

However, even if there are too many sources to combine with the Yamazuki source for this type of motor bike, in competition with the source “I sell”, the offer of the private individual can be presented by default if the end user is interested in the same browsing session to the place “Fontainebleau” which is being the place of sale of this motor bike. Indeed the competition of data to be combined with the Yamazuki source (for motor bike RS750) will be then reduced. The precise scenario is the following: The end user accesses in the same browsing session not only the site “Yamazuki” but also a site “Castles” in which the user selects the Fontainebleau row. In this case, insofar as the source “I sell” is automatically combined by default with these two sites, the offer of the motor bike of the private individual is presented:

Yamazuki+Castles+I sell

| | | | | | | |
|---|---|---|---|---|---|---|
| Type of | | | | | | Validate |
| motor bike | Caratéristiques . . . | Place | Details . . . | Price | Validate since | until |

| | | | | | | |
|---|---|---|---|---|---|---|
| RS750 | . . . | Fontainebleau | . . . | 5000 | March 23rd, 2007 | Null |
| | | | | | 17:00 | |

In a even more refined approach, even the content of the data presented can be taken into account in countings. Let us consider the following simple example where the values of a particular column are taken into account in countings. A user accesses on the Web a search engine and provides it a key word “fly” representing her personal interest. An extractor (as already described) presents, in the form of table, the result returned by the search engine as follows:

Search Engine

| Key word | URL | Field | Valid since | Valid until |
|---|---|---|---|---|
| fly | — | Fly fishing | March 23rd, 2007 17:00 | Null |
| — | | | | |

Assume here that the search engine provides, in a column “Field”, the field (in fact “Fly fishing”) corresponding to the key word (“fly”) given. If a relatively large number of users had, while visualizing precisely the value “Fly fishing”, combined the source “Vendeur1” (assume here that “Vendeur1” is a book seller specialized in the field “Fly fishing”) with this site “Search engine”, “Vendeur1” will be automatically combined:

Search Engine+Vendeur1

| Key | | | Principal | | | | | Valid |
|---|---|---|---|---|---|---|---|---|
| word | URL | Field | author | Title | Seller | Price | Valid since | until |
| fly | . . . | Fish with the | Author1 | Titer1 | Vendeur1 | 25 | March 23rd, 2007 | Null |
| | | fly | | | | | 17:00 | |
| . . . | | | | | | | | |

One now will see another example and will introduce a method of suggestion which does not reflect only one previous case of mapping, but an implicit sequence of several previous cases of mappings.

In the table “My articles” below, a user associates an article (“Title10”, “Author10”) with a book (“Author1”, “Title1”) which she considers as as being very “popular” in the field of the article.

My Articles

| | Article | | | | Book | | | |
|---|---|---|---|---|---|---|---|---|
| Article | First | | | Date | Principal | Book | | Valid |
| Title | Author | Review | URL | publication | author | Title | Valid since | until |
| Title10 | Author10 | Revue10 | Url10 | June 2006 | Author1 | Title1 | March 23rd, | Null |
| | | | | | | | 2007 16:00 | |

She then maps the columns “Book Principal author” and “Book Title” (which identify the said very popular book in “My articles”) with the columns “Principal author” and “Title” of the data source “Vendeur1”.

Vendeur1+My Articles

| Principal | | | | | | | | |
|---|---|---|---|---|---|---|---|---|
| author (Book | Title | | Article | | | | | |
| Principal | (Book | Article | First | | | Date | Valid | Valid |
| author) | Titrates) | Title | Author | Review | URL | publication | since | until |
| Author1 | Titer1 | Titer10 | Author10 | Revue10 | Url10 | June 2006 | March | |
| | | | | | | | 23rd, | |
| | | | | | | | 2007 | |
| | | | | | | | 16:00 | |

Thus, as already described, when later the user accesses the source “Vendeur1” and is interested in this same book, its combination with “My articles” is recalled to her automatically and the article “Titer10” “Author10” is presented to her.

But even when the user accesses another source (let us say “Vendeur2”) for which the combination with “Vendeur1” would have been automatically suggested, its source “My articles” can be suggested to her.

Indeed, this is justified by the fact that “My articles” would in any case have been suggested to her to be combined indirectly via “Vendeur1” (and the user could simply have made disappear the rows and hide all the columns coming from “Vendeur1” to revert exactly to the same case).

Thus, a “mapping chain” existing between “Vendeur2” and “My articles”, and the mapping of “Vendeur1” in “My articles” privileged (strong weight) because being established by the user herself, this last source will be automatically combined by default. The source “My articles” is thus recalled to the user even if she doesn't remember any more neither its name, nor even the name of the source “Vendeur1” with which she had combined it.

1. Method implemented in a data-processing environment to identify enrichment information, characterized in that it comprises the following steps:
(a) access through the network a first information source in order to obtain a first information in response to a first request;
(b) convert the said first information into a first data set (set of data rows) structured according to a plurality of first attributes;
(c) apply context information to a source of mapping in order to identify at least one second information source able to deliver information to enrich the first information;
(d) access through the network the second information source in order to obtain a second information as a response to a second request containing one or more criteria contained in the first request and/or one or more attribute values of the first data set;
(e) convert the said second information into a second data set structured according to a plurality of second attributes of which at least some are related to first attributes as per the attribute mapping information provided by the source of mapping, and
(f) present data comprising the data of the first data set and the data of the second data set, combined in function of the said mapping information.

2. Method implemented in a data-processing environment to identify enrichment information, characterized in that it comprises the following steps:
(a) access through the network a first information source in order to obtain a first data set structured according to a plurality of first attributes in response to a first request;
(b) apply context information to a source of mapping in order to identify at least one second data source able to deliver data to enrich the first data set;
(c) access through the network the second data source in order to obtain a second data set structured according to a plurality of second attributes in response to a second request containing one or more criteria contained in the first request and/or one or more attribute values of the first data set, the second attributes being related to first attributes as per the attribute mapping information provided by the source of mapping; and
(d) present data comprising the data of the first data set and the data of the second data set, combined according to key attributes predetermined among the second attributes.

3. Method implemented in a data-processing environment to identify enrichment information, characterized in that it comprises the following steps:
(a) access through the network a first information source in order to obtain a first data set structured according to a plurality of first attributes in response to a first request;
(b) apply context information to a source of mapping in order to identify at least one second data source able to deliver data to enrich the first data set;
(c) access through the network the second data source in order to obtain a second data set structured according to a plurality of second attributes in response to a second request containing one or more criteria contained in the first request and/or one or more attribute values of the first data set, the second attributes being related to first attributes as per the attribute mapping information provided by the source of mapping; and
(d) present data comprising the data of the first data set and the data of the second data set, combined in response to the existence of alternative values, in the second data set, of second attributes mapped on first attributes.

4. Method according to claim 3, in which the said alternative values are selectively displayed according to the position of a pointing device on a value of the first data set, alternative values for the attribute corresponding to the value on which points the pointing device being displayed.

5. Method implemented in a data-processing environment to automatically enrich data organized in a multiplicity of (multidimensional) attributes provided by a data source such as a web site, characterized in that it comprises the following steps:
(a) access a first data source to obtain first data;
(b) automatically obtain data alternative to the first data, from at least one second data source;
(c) automatically obtain data complementary to the first data, from a third data source; and
(d) combine the said alternative data and the said complementary data, so as to selectively present the said first data, the alternative data and the complementary data.

6. Method according to claim 5, in which the said third data source providing the data complementary to the first data source is the second data source itself.

7. Method according to one of claim 5 or 6, in which the step (c) further consists in obtaining from the first or the third source, data complementary to the said alternative data obtained from the second source.

8. Method according to one of claims 5 to 7, in which the step (b) further consists in automatically obtaining from the first source, data alternative to the alternative data obtained from the second source, these additional alternative data being also enriched at the step (c).

9. Method according to claim 8, in which the step (c) comprises a sub-step for detecting the existence of alternative attributes in the first or second source.

10. Method according to one of claims 5 to 9, comprising moreover a step of conversion of the data resulting from the data sources into data set structured according to a plurality of attributes.

11. Method according to claim 10, comprising moreover a step of graphic treatment of the presentation of the first data provided by the first source to include in there the alternative data and the complementary data.

12. Method according to claim 11, in which the alternative data and the complementary data are presented selectively according to the attribute values selected by the user by using a pointing device at the level of the original presentation of the first data.

13. Method according to one of claims 5 to 12 comprising a mapping of attributes for each pair of sources of which the data are to be combined.

14. Method according to claim 13, in which the step (b) comprises filtering on one or more attributes.

15. Method according to one of claims 13 and 14, in which the step (c) comprises taking into account meta-data of dependencies between attributes.

16. Method according to one of claims 5 to 15, comprising moreover a step consisting in automatically obtaining data complementary to the alternative data.

17. Method according to one of claims 5 to 16, comprising moreover a step consisting in automatically obtaining data alternative to the complementary data.

18. Method according to one of claims 5 to 17, comprising moreover a step consisting in automatically obtaining data complementary to the complementary data.

19. Method according to one of claims 5 to 18, comprising moreover a step consisting in automatically obtaining data alternative to the alternative data.

20. Method according to one of claims 5 to 19, in which the data sources are selected among the traditional multidimensional data sources and the data sources whose attribute values can be represented by domains of values or constraints on values.

21. Method according to claim 20, in which the said constraints depend on variables representing references to values of attributes for the same data row or for another data row.

22. Method according to claim 21, in which, when an attribute of a data row (R) which enriches a first source comprises a reference to an attribute of another data row (R′), or reciprocally when an attribute of another data row (R′) comprises a reference to an attribute of a data row (R) which enriches a data row of the first source, the said other data row (R′) is added in the combined data (S1r), even when no data row of the first source corresponds to it.

23. Method according to claim 22, in which the said other data row is included in the step (d) only in the presence of consistent constraints.

24. Method according to one of claims 22 and 23, in which there exist attributes of the type “real-time” and temporal constraints on them, and in which the step (d) is implemented by taking into account constraints on attributes of the type “Real-time” to allow a management of enrichments by alternative data and complementary data taking the time into account.

25. Method according to claim 21, in which the step (d) involves using a constraint solver.

26. Method according to one of claims 5 to 25, in which the data sources from which the data of the first data source are to be enriched comprise resources belonging to a user context which is configurable.

27. Method according to claim 26, in which the user context comprises web pages in other tabs of a web browser, the said browser being the means to access the data sources.

28. Method according to claim 26 or 27, in which the user context comprises web pages pertaining to a recent browsing history in a web browser.

29. Method according to one of claims 26 to 28, in which the user context comprises web pages pertaining to the context of user of another user having a proximity relationship with the user in question.

30. Method according to one of claims 26 to 29, in which the user context is obtained according to the geolocation information of the user.

31. Method according to the claim 26, in which the user context is obtained from the content of data sources previously accessed by the user.

32. Method according to one of claims 5 to 31, in which the step (d) comprises selective collapsing/expanding of data rows from the first data source and the enrichment data sources.

33. Method according to claim 32, in which, when the said first data gather a plurality of data rows of the said the first source and aggregate their values, then the step (d) accordingly aggregate the enrichment data rows of the first data.

34. Method to carry out a mapping between attributes of two multidimensional data sources, in order to implement the method according to one of claims 1 to 33, each data source being able to return results in response to a request, characterized in that it comprises the following steps:
(a) display results of two similar queries applied to the two data sources in two respective display zones,
(b) by actions using a pointer device, establish correspondences between displayed data from the first source and displayed data from the second source, and
(c) map the attributes of the data of the first source and the second source for which correspondences were established.
